(19) United States
(12) Patent Application Publication
(10) Pub. No.: US 2008/0094427 A1
(43) Pub. Date: Apr. 24, 2008

(54) Asynchronous Video Capture for Insertion Into High Resolution Image

(76) Inventor: Jeroen Debonnet, Marke (BE)

Correspondence Address: BACON & THOMAS, PLLC, 625 SLATERS LANE, FOURTH FLOOR, ALEXANDRIA, VA, 22314, US

(21) Appl. No.: 11/666,291

(22) PCT Filed: Oct. 28, 2005
(86) PCT No.: PCT/BE05/00154

§ 371 Date: Apr. 26, 2007

(30) Foreign Application Priority Data
Oct. 29, 2004 (EP) 04447241.3

(51) Int. Cl. G09G 5/02

(52) U.S. Cl. 345/698

(57) ABSTRACT

A display system has a first resolution video buffer 20, and can insert a second resolution analog video signal, the first resolution being higher than the second resolution. It can sample the second resolution video signal and insert it 50 without substantially reducing the resolution of the image. An advantage over software solution is more independence from software standards. The sampling can involve asynchronous over-sampling 130 to two or more states, adequate for recreating text or attributes. Then a re-sampler 52 uses a pixel clock derived 54 by counting coincidences of image and clock transitions, and adjusting a clock phase or frequency to minimize the count.

### FIELD OF THE INVENTION

This invention relates to display systems, and in particular systems for asynchronous capture of a lower resolution video stream for insertion into a higher resolution video.

### DESCRIPTION OF THE RELATED ART

In high-resolution display systems, the boot process is never fully visible on the high resolution monitor, because this high resolution monitor does not support the low-resolution video timings (DOS, VGA). An additional low-resolution monitor is used to view the boot process, if this is needed for diagnostic purposes for example.

As is explained in U.S. Pat. No. 5,799,204, many personal computers use a standard basic input-output system (BIOS) that requires the presence of a standard video controller (typically, a video graphics adapter—VGA) on an internal bus. Without the standard video controller, a computer with standard BIOS is unable to boot up. The standard video controller is usually found on the video card that links the monitor to the internal (PCI) bus. Systems using advanced graphics controllers, offering higher resolution have generally been run on computers specifically designed for processing graphics. Because of the requirement of standard BIOS that a standard video controller be present on the bus, users have been unable to use the capabilities of advanced graphics controllers on a standard personal computer without using a non-standard BIOS that does not require the presence of a standard video controller. There can be, however, disadvantages to using non-standard BIOS; generally, the use of a non-standard BIOS increases the likelihood that other peripherals and other software will not be compatible with the computer.

Hence currently available high-resolution display systems typically display the BIOS settings or the boot process of a computer on a separate low resolution monitor. The low resolution video signal is not compatible with the high resolution monitor, because this high resolution monitor does not support the low-resolution video timings (DOS, VGA). As an example, the displays used in ATC (Air Traffic Control) may have 2K×2K resolution displays and are not able to display a DOS or VGA video signal. It is inconvenient to provide a low resolution monitor especially where it is used only infrequently.

U.S. Pat. No. 5,799,204 proposes using two graphics cards or subsystems, each producing a video output, with a switch to select one of the two video outputs for the display. In order to satisfy the BIOS's requirement of a standard-video-controller subsystem, a VGA subsystem is connected to a PCI bus slot. An advanced graphics subsystem 42 is attached to a separate PCI bus slot. Both of these subsystems are connected to the monitor through a switch that permits either the VGA subsystem or the advanced graphics subsystem to transmit video signals to the monitor. The switching function may be accomplished in a number of ways. The advanced graphics subsystem preferably provides a video select signal to the switch to cause the switch to select either of the two subsystems. This video select signal would normally be triggered after the BIOS boot-up, when the software for the advanced graphics subsystem is loaded and executed and then indicates to the advanced graphics subsystem to take over the video processing function from the VGA subsystem (or other standard-video-controller subsystem). The VGA subsystem is typically only used during the boot process and in full-screen DOS mode. The user can select to display either VGA mode or advanced-graphics mode.

It is also known to provide “picture in picture” software to enable a video signal to be viewed in a small window over a main image. This is not usually suitable for viewing BIOS for example, as it adds to the complexity of the software and may make the software dependent on the type of hardware and so introduce compatibility problems. It is also known to have a picture in picture integrated circuit for use in consumer televisions, for receiving two video streams of the same resolution and video timing standard, and compressing one of them by sub-sampling in vertical and horizontal directions, by a factor of 4 or so, to fit into a small frame buffer. This “thumbnail” image is then read out according to a pixel counter and line counter synchronized to the main video signal, so as to appear as a picture within the main video signal. These are not suitable for viewing text from a BIOS for example, as the sub-sampling will make text unreadable.

Other software solutions are possible, for merging video images, but resolving only part of the problem, if they are not able to access e.g. the BIOS menu. Some systems, currently available, show the operating system boot process on the high-resolution monitor, by means of a special video driver which is loaded early in the unix/linux/solaris boot process, or even rewriting the video BIOS.

Regarding receiving a video signal without a pixel clock, a method of using the first and the last pixel to obtain the correct total number of pixels, providing the first and the last pixels comprise information, is described in U.S. Pat. No. 5,767,916. The document describes the determination of the total number of pixels based on the knowledge of the horizontal resolution and information about the position of the first and last sampled active pixel in a line. The document furthermore describes the use of phase comparison to obtain equalisation of the phase of the sample and pixel clock signal.

### SUMMARY OF THE INVENTION

An object of the invention is to provide improved apparatus or methods, especially display systems, and in particular systems for asynchronous capture of a lower resolution video stream for insertion into a higher resolution video. According to a first aspect, the invention provides a display system adapted for outputting a first video output signal having a first resolution, the display system having a video buffer adapted for buffering the video output signal having the first resolution, the system being arranged to receive an analog video signal having a second resolution, the second resolution being lower than the first resolution, and having a circuit for sampling the second, lower resolution video signal to two or four levels per sample, a means for recreating an image from the samples of the second resolution video signal, without substantially reducing the resolution of the image, and circuitry arranged to output the recreated image as part of the first video output signal. The circuit is preferably implemented in hardware. The display system may thus be adapted for outputting a first, higher resolution video output signal.

An advantage of this arrangement over providing a second monitor is the convenience. An advantage over switching between a pair of video outputs is simplicity. This is because the monitor need not be able to handle different resolutions and different video timings, and there is no need for the additional complexity of two video outputs and the switch. An advantage over software solutions is more independence from software standards used in a host computer, and independence from any software used for generating the first high resolution image. Furthermore the output of the existing buffer and the monitor can be used without modification; hence it need not be limited to particular video standards. Hence the solution can be more compatible with different computers, and with different versions of high resolution image processing software for example. It is useful to avoid substantial reduction in resolution, so that for example text in the second lower resolution video is still legible, and to reduce circuit complexity and cost.

Video cards may provide the second, lower-resolution and the first, higher-resolution video output as 2 separate outputs on the same board (dual head configuration). An embodiment of the invention can be applied to such hardware to overlay the lower-resolution image as a PIP (picture-in-picture) into the higher-resolution output. The advantage of being completely software independent applies: all the existing standards for BIOS, VGA BIOS remain untouched.

A feature for the present invention is the sampling comprising sampling to two or more levels or states per sample. The lower the degree of quantization of the sampling, the simpler and cheaper are the circuits for recreating the image, for example less storage is needed, and transitions in the image are easier to detect. Two states implies one threshold and one bit. Four states implies two bit values in binary terms and three thresholds. One or two bits are usually adequate for recreating text or recreating attributes such as bold text or basic colours.

Another such additional feature is a pixel clock generator for generating a pixel clock for the sampling.

Another such additional feature is the sampling comprising an asynchronous over-sampling, and a re-sampling according to the pixel clock. The asynchronous over-sampling may be performed by an over-sampler comprised in the display system. Re-sampling according to the pixel clock may be performed by a re-sampler comprised in the display system.

Another such feature is a single integrated circuit incorporating the means for recreating the image, and inserting it into the buffer, together with means for processing the first, higher resolution video. This is made practical by the reduced complexity of the second, lower resolution video processing, and helps minimize the costs of adding the second, lower resolution video processing to an existing first higher resolution system.

Another such additional feature is a circuit for dynamically adjusting a phase of the pixel clock.

Another such additional feature is a circuit for dynamically adjusting a frequency of the pixel clock.

Another such additional feature is a circuit for determining a phase error of the pixel clock by determining how many transitions of the clock, e.g. being a generated clock, coincide with a transition in value of the lower resolution video signal. A generated clock may be one of a multiple phase-shifted clocks created from a reference clock. A phase error of the pixel clock may be a phase difference between the pixel clock and the video signal. A phase error of the pixel clock may be a phase difference between the pixel clock and a clock associated with the video signal. The video signal transitions should be in between clock transitions. The video signal transitions may be changes in value of the second lower resolution video signal. The phase and/or frequency can be adjusted to minimize or avoid the sampling clock transitions coinciding or nearly coinciding with video data transitions. This can provide improved jitter suppression. The video signal transitions are easier to detect and accumulate if the quantization level is low, e.g. one or two bits.

Another such additional feature is circuitry arranged to determine the counts for samples sampled by clocks, e.g. generated clocks, having different phases, and a selector for selecting a clock according to the counts. The generated clocks may be multiple phase-shifted clocks created from a reference clock. The pixel clock may be selected from the generated clocks. This helps enable adjustment of the clock to reduce jitter, without the additional complexity of a PLL for example.

Another additional feature is the circuitry arranged to output the recreated image being arranged to insert the samples into the buffer for the first high resolution image. The insertion can be by replacement of or combination with existing pixels of the first, higher resolution image for example. Compared to merging the video streams after the buffer, this helps reduce the need for additional high speed circuitry, and so reduces complexity and cost.

Another additional feature is the second, lower resolution image being stored without resealing. This can keep the complexity and costs low.

Another additional feature is a circuit for detecting a line format of the second, lower resolution video signal and adapting the sampling according to the detected line format. This can further increase the universal applicability and compatibility of the circuit to more systems. A line format may be information related to the Hsync signal. It may e.g. be a frequency of the Hsync signal.

The system may comprise a graphics controller with a first resolution output and a second resolution analog output, the first resolution being higher than the second resolution, the first resolution output being digitally connected to a processing engine for video processing, and the second resolution analog output is connected to a video connector. This makes a compact arrangement. The graphics controller may be connected to a processing means performing any of the buffering, recreating an image or outputting the recreated image. An auxiliary display is connected to the video connector. This allows monitoring a debugging during operation of the high resolution main display.

Another aspect of the invention provides a system comprising a computer, a first, higher resolution video system, and a display system as set out above, the display system being coupled to display a first, higher resolution video output from the first, higher resolution system, and being coupled to incorporate a second, lower resolution video stream from the computer system into the first, higher resolution video output.

Another aspect of the present invention provides a method of displaying a lower resolution image, the method comprising:

providing a first, higher resolution video output,

receiving a second, lower resolution analog video signal;

sampling the second, lower resolution video signal,

recreating an image from the samples of the second, lower resolution video signal, without substantially reducing the resolution of the image, and

outputting the recreated image as part of the first, higher resolution video output.

Any of the additional features can be combined together and combined with any of the aspects. Other advantages will be apparent to those skilled in the art, especially over other prior art. Numerous variations and modifications can be made without departing from the claims of the present invention. Therefore, it should be clearly understood that the form of the present invention is illustrative only and is not intended to limit the scope of the present invention.

### BRIEF DESCRIPTION OF THE DRAWINGS

How the present invention may be put into effect will now be described by way of example with reference to the appended drawings, in which:

FIGS. 1, 2, 3, 4, 5 and 7 show embodiments of the invention, and

FIGS. 6 and 8 show timing graphs relating to embodiments of the invention.

### DESCRIPTION OF THE PREFERRED EMBODIMENTS

The embodiments are described with reference to “first, high resolution video signals” and “second, low resolution video signals”. This is not intended to relate to absolute resolutions of the video signals, but is only intended to indicate that the first video signals have a higher resolution than the second video signals.

The embodiments described are intended to provide a very low cost system to capture low resolution video signals (such as well known formats including DOS, VGA, SVGA), with acceptable quality. One application is to display the low-resolution BIOS (Basic Input Output System) and OS (Operating System) boot screen on a high resolution monitor, used for displaying higher resolution video.

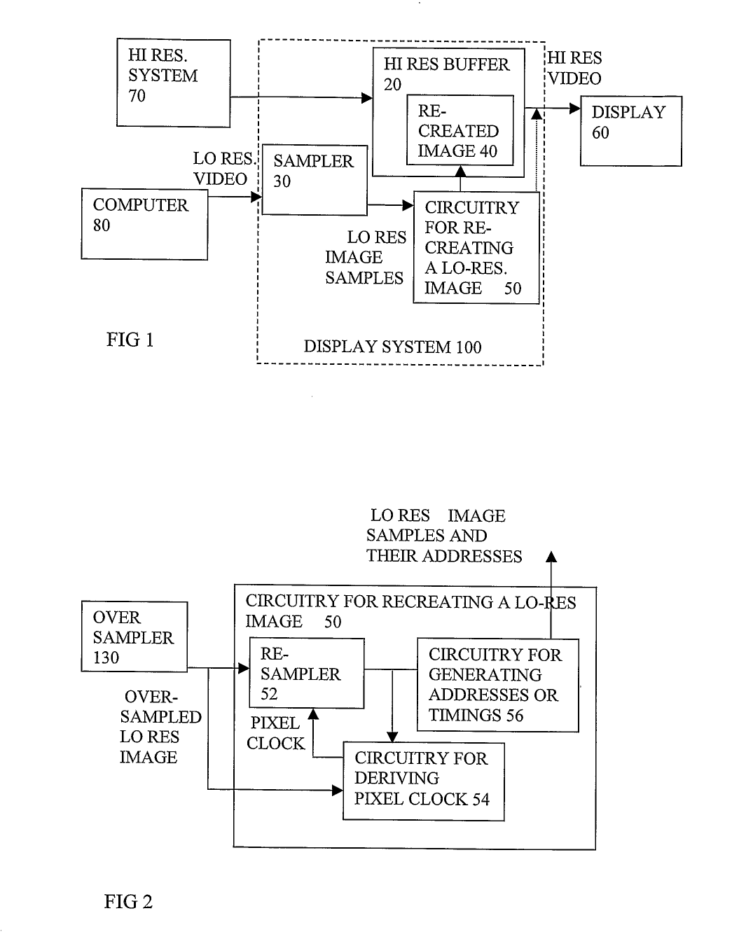

A first embodiment of the invention, illustrated in FIG. 1 shows a display system 100, receiving a high resolution video signal (e.g. analogue or digital, and e.g. greater than 1 k×1 k resolution) from a high resolution system 70, and outputting high resolution video to a display device 60, such as e.g. a projection TV, CRT or LCD or plasma, or EL, or any other type of device. A computer 80 provides a low resolution video output such a DOS, VGA, or SVGA output to the display system. The computer is typically used to control the high resolution system, and so it is useful to have both video outputs on the same screen.

In the display system, a high resolution buffer 20 can be a frame buffer or a smaller buffer. A sampler 30 takes the analog low resolution video and produces low resolution image samples, without substantial loss in resolution. These are passed to circuitry 50 for recreating the low resolution image. This can involve determining lines, using an hsync input for example, and storing one or more lines in a line buffer, to recreate part of the image at a time. If the high resolution and low resolution video has different frame timings, then a frame buffer can be used for either or both video streams to enable them to be synchronized. To incorporate the low resolution image in the higher resolution videostream, the low resolution image can be stored in a frame buffer of the higher resolution stream for example. The low resolution image can be written in at any timing, and the position on screen can be set by offsetting the addresses of the writing operations. Readout timing can be provided by the buffer. An alternative is shown by a dotted line, the circuitry 50 can pass a synchronized version of the low resolution video stream for merging with the higher resolution video output after the high resolution buffer.

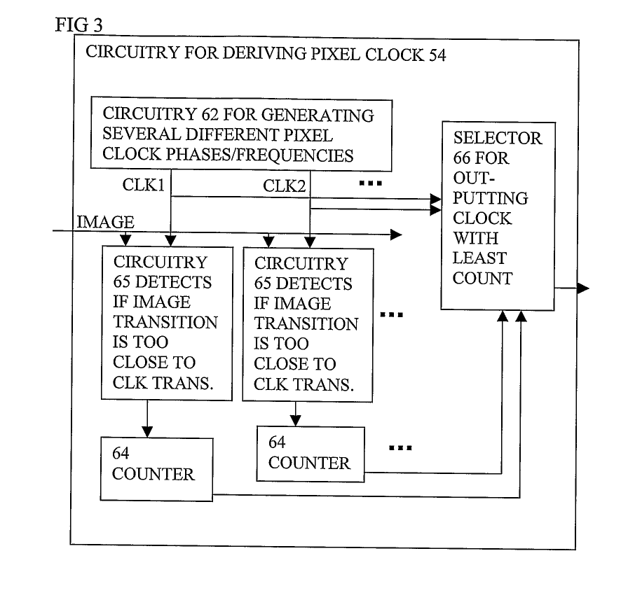

FIG. 2 shows one way of implementing the circuitry for recreating the lo-res image 50, as used in FIG. 1 or in other embodiments. An over sampler 130 provides asynchronously over-sampled samples of the lower resolution video signal to a re-sampler 52. This re-samples the samples using a pixel clock. Circuitry 54 is provided for deriving the pixel clock from the over-sampled signal, e.g. by a PLL or other circuitry, an example is described below with reference to FIG. 3. The output of the re-sampler is fed to circuitry 56 for generating timings or addresses for storing or buffering the image or parts of it, either in the high resolution buffer or elsewhere. Alternatively this circuitry can produce a signal suitable for and synchronized to enable merging with the output of the high resolution buffer, using conventional analog or digital circuitry.

FIG. 3 shows an example of circuitry for deriving the pixel clock 54, for use in the example of FIG. 2 or in other embodiments. Circuitry 62 generates several different pixel clocks, CLK1, CLK2, having different frequencies or different phases. There can be more than two of these, as shown. Each is fed to circuitry 65 for detecting if a transition in an image signal, is too close to the clock transition, indicating the pixel clock is not at the correct phase. A counter 64 counts the detections. A selector 66 is provided for outputting whichever pixel clock has the least count, indicating its phase and frequency is the best. This can enable the pixel clock to be derived from a video signal which typically only has line and frame sync signals explicitly contained in it.

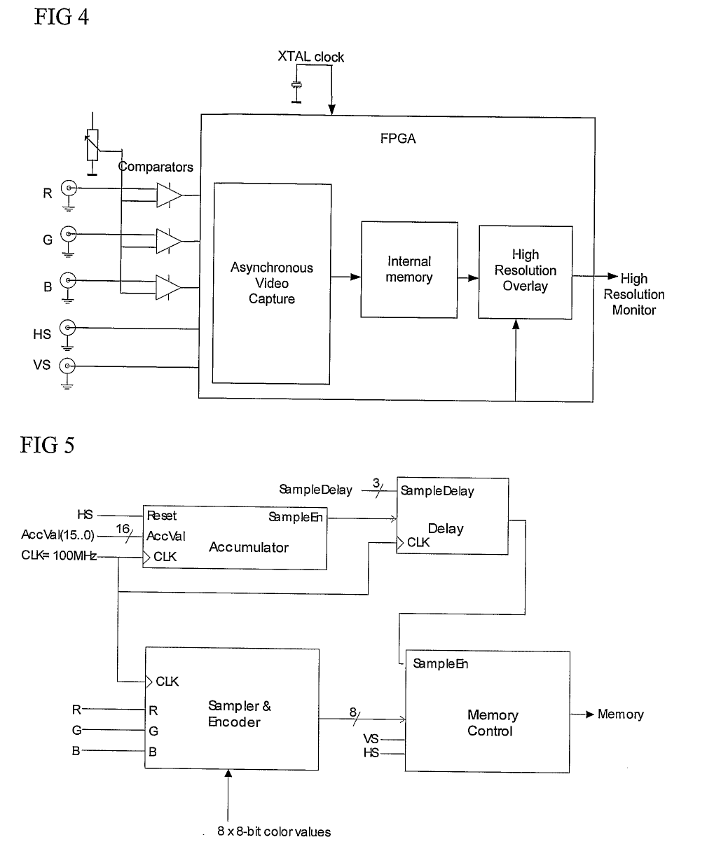

Another embodiment is shown in schematic form in FIG. 4. This system uses 1-bit AD conversion, using only a simple comparator on the R,G,B video lines, for comparing the analog input to a single threshold, then routes the comparator outputs as samples to an FPGA or other type of digital logic. The FPGA thus receives 5 digital input signals: R,G,B, HS and VS. The R,G,B signals are then asynchronously over-sampled with a XTAL clock (such as a 100 MHz clock). If desired, the comparator can be replaced with a simple A-D convertor to produce more quantization of the analog signal, e.g. two or more bits per pixel.

A system of digital logic then picks the best of the over-sampled pixel samples, to reconstruct the original image pixel sequence, with substantially no drop in resolution, so that text is still legible. This includes an asynchronous video capture part, feeding internal memory, and a high resolution overlay part, to produce a high resolution output including the lower resolution image. These parts will be explained in more detail below. The reconstructed pixels are written to embedded dual-port internal memory. They only need a small amount of memory because of the 1-bit colour depth. (e.g. DOS timing: 720×400×3 bits=864000 bits, which is easily available in today's FPGA's and ASIC's.) Having a copy of the low-res image in memory, now it is easy to use standard practice OSD (On Screen Display)-techniques to genlock & insert this image somewhere in the high resolution video path. Various possibilities can be conceived, including:

1) in an embedded display system: writing it directly to OSD memory,

2) superimposing it onto the high-resolution analog video output of a video card, or

3) mixing it with the high-resolution digital video output of a video card.

Regarding the standard video processing electronics for a high-resolution monitor, the digital video always passes through some FPGA or ASIC to do the necessary video processing (e.g. gamma lookup tables, scaling, OSD insertion, . . . ) before reaching the display device. Hence, looking at the block schematic of FIG. 4, it can be seen that the only components that need to be added to the standard video processing electronics, are the 3 comparators+a voltage divider to provide the threshold voltage. Cost at the ASIC or FPGA is only 5 pins: the digital R,G, B, HS (horizontal sync) and VS (vertical sync) signals. So, the added cost to implement this on a system, is minimal—provided there is enough free “space” in the existing FPGA/ASIC.

It can also be seen that no PLL is needed to reconstruct the video clock of the low-resolution video. The video signal will be sampled asynchronously. This simplifies the circuit and reduces the amount of space needed in the FPGA/ASIC, though of course an alternative embodiment is to use a PLL to derive the clock to synchronise the sampling. The different blocks in the above block schematic will now be explained.

The A/D conversion with a comparator is suitable for applications such as visualizing the BIOS & boot screens, where it is not necessary to digitize the video signal at a high quality. Not many different colours are used, and these colours are most of the time saturated. Because of this, the A/D conversion of these video images can use a simple comparator on the R,G,B channels: if the analog video is above a threshold voltage, then the colour is ‘1’. If the analog video is below the threshold voltage, then the colour is ‘0’.

This way, one pixel will be represented with a 3-bit value:

000 black

001 red

010 green

100 blue

011 yellow=red+green

110 cyan=blue+green

101 magenta=blue+red

111 white=red+green+blue

If the threshold is chosen at 33% of the analog video amplitude, both “grey” and “white” (highlighted) text will both be visible.

FIG. 5 shows an example of the asynchronous capture part of FIG. 4, in more detail. As there is no PLL available to reconstruct the low-resolution video clock, (for the sake of cost reduction), the video signal will be sampled asynchronously, on the system clock CLK. This is a clock coming from a crystal oscillator. This clock needs to be ideally over 4 times higher than the low resolution video clock. (e.g.: VGA timing: 25 MHz video signal, CLK: 100 MHz crystal clock).

To achieve good video sampling, it is useful to find out which samples can be taken to result in an undistorted video image. The “Accumulator” in FIG. 5 takes care of this. The Accumulator generates a SampleEn signal, synchronous with the CLK. SampleEn is high during 1 CLK for each incoming pixel.

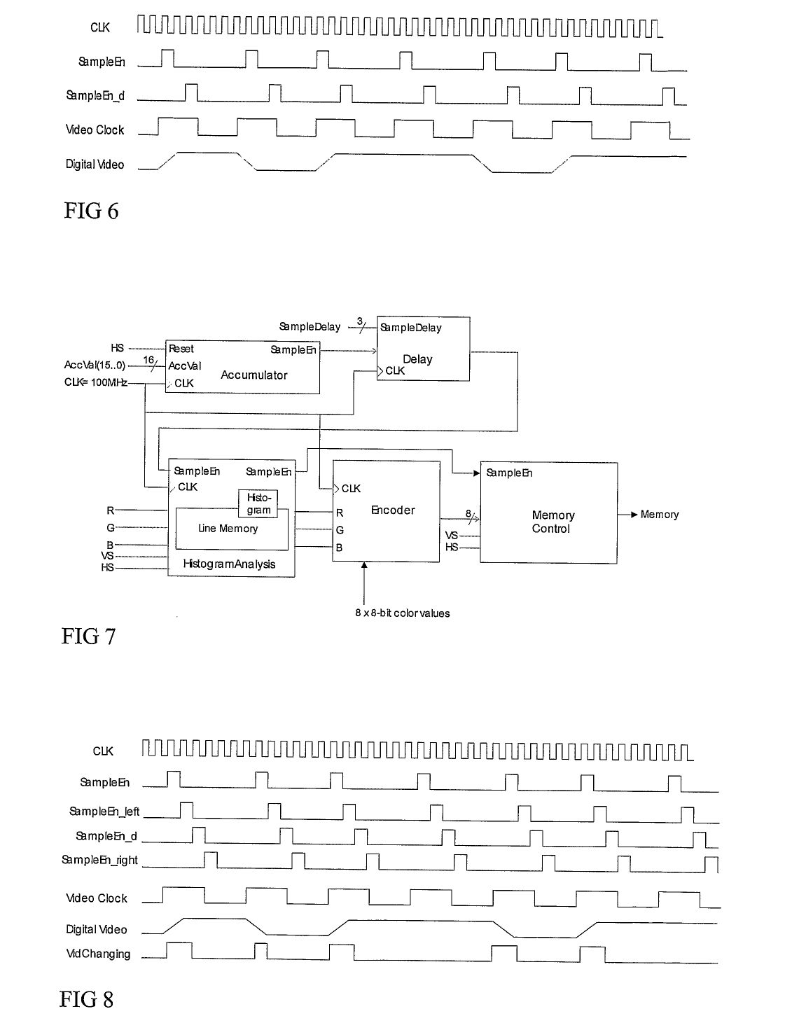

As shown in FIG. 6 the Digital Video is coming into the system synchronous to the Video Clock (pixel clock), which is not known, so needs to be derived. The SampleEn signal is generated by the Accumulator, giving 1 pulse for every incoming pixel.

Accumulator

The Accumulator generates this SampleEn signal as follows. The Accumulator is a simple binary adder, which increments every CLK with a adjustable amount AccVal. When the adder generates an overflow, SampleEn is high for 1 CLK. The adder is being reset every video line by the HS (horizontal sync) signal. The necessary bit depth of the Accumulator can be calculated, depending on the line width (=amount of pixels in one line) and the wished accuracy of SampleEn.

Sample Delay

As can be seen in FIG. 6, there is a SampleEn pulse for every incoming video pixel. But the SampleEn is not guaranteed to fall in the middle of the pixel; resulting in an image with a lot of jitter. Therefore, a Delay block shown in FIG. 5 is used to delay the SampleEn pulse by an adjustable amount of async (100 MHz) clock pulses, to make sure the pixel is sampled where it is stable.

Sampler & Encoder

This block shown in FIG. 5, converts the 3-bit RGB pixel colour to the colour system used in the high-resolution display system, before it is written into the overlay memory. In fact, here there is a choice, one option is to store the 3-bit RGB pixel directly in memory, and convert it to the display's colour system when retrieved from memory. This will obviously use the least amount of memory: 3 bit*horizontal size*vertical size: for a DOS timing, this is 3*720*400=864000 bits. Or, the conversion to the display's colour system can be done before storing into memory, if there is already an overlay memory available in the display system. In FIG. 5, it is assumed that an overlay memory is available with a 8-bit colour depth, like a standard OSD (on-screen display) memory. The lookup-table with the 8 values to which the 3-bit RGB needs to be converted, is provided to this block.

Memory Control

This block in FIG. 5 makes sure the sampled pixels are placed in the correct place in the overlay memory. It cuts away the horizontal backporch (=the sampled pixels between the HS and the actual start of the active area of the image), it ignores the vertical blanking (it only writes the active lines to memory).

FIGS. 7, 8 Asynchronous Video Capture with Jitter Suppression

Depending on the possible over-sampling rate (=CLK/Video Clock) and the quality of the incoming low-resolution video signal, too much jitter can still be present after asynchronous sampling. If this is the case, it will not be possible to find an ideal setting for the SampleDelay parameter, to form a stable image. In order to remove remaining line-jitter, it is possible add some intelligence to the sampling hardware, by add an intelligent “HistogramAnalysis” block in the input sample path. This is shown in FIG. 7, while FIG. 8 shows a graph of timings relating to FIG. 7.

Instead of processing every pixel as it comes into the system, the HistogramAnalysis block caches a full line in a local memory. Not only the samples flagged with the SampleEn signal will be cached, but also the samples surrounding the SampleEn. Taking the example of a DOS timing (720 pixels), 1 full line cached together with the left and right neighbour samples: this will require a local memory of: 3 bits*720*3=6480 bits.

Define Sample[x] the 3-bit RGB sample being taken on CLK at CLK edge number x;

Define SE[y] the clock edge number where SampleEn selects pixel number y.

While the line is being cached, the HistogramAnalysis block checks for changes in the incoming RGB video. The algorithm builds a histogram of the amount of changes detected at every cached sample position. (e.g., when caching 1 line with it's left and right neighbour, this will result in a histogram of 3 values: the amount of changes detected at it's left neighbour, the amount of changes detected at the sample, and the amount of changes detected at it's right neighbour). A “change” is defined, when Sample[x]≠Sample[x+1]. See the example timing diagram in FIG. 8: the signal VidChanging is synchronous to CLK, and is 1 when the sample at this clock edge is changing.

Once a full line (or a part of a line) has been cached & analyzed in the histogram, it can be seen which of the sample positions has been the least stable: this sample position has most changes logged in the histogram. The “best” sample position now can be taken as the sample position the farthest away from the least stable position. In FIG. 8, it is obvious that the best sample position is the right neighbour. The cached stream of samples at the “best” sample position to the Memory Control block can be read out and written into the internal memory. The rest of the arrangement follows the embodiment of FIGS. 4 and 5. Although as described, a phase of the video clock (pixel clock) is adjusted, it is equally possible to adjust a frequency, by adjusting the value Acc Val, fed into the accumulator. This is shown as a 16 bit value, so quite fine adjustments are possible.

Also feasible is a line counter fed by Hsync and Vsync, to determine which of a number of video standards is being fed into the lower resolution video input, to make the display system compatible with a variety of computer systems without manual configuration. The system of the present invention can be used in a flat panel display, e.g. a fixed format display, such as a 2K×2K resolution LCD monitor, preferably with integrated computing hardware. A graphics controller such as a 3DLABS P10 controller (see www.anandtech.com/video/showdoc.html?I=1614) can be integrated into the LCD display. This controller has 2 video outputs (dual head). The high-resolution port of the graphics controller is digitally transferred to a processing engine, especially a digital programmable logic element such as a programmable gate array, e.g. an FPGA, which does the video processing, OSD overlay and transmission to the display, e.g. LCD. The standard-resolution analog output (lower resolution than the high resolution port and used for start up screen) of the P10 graphics controller is wired to a suitable connector, e.g. a VGA connector. Via this port, an auxiliary display can be used as second head of the monitor.

Also, on this analog output port, the BIOS and boot graphics are displayed. So, the R,G,B, HS and VS signals of the VGA connector are used to feed the Asynchronous Video Capture system of the present invention, which is implemented inside the FPGA. The overlay memory used, is the OSD memory, typically implemented in DDR-SDRAM (Dual Data Rate Synchronous Dynamic Random Access Memory) and has a colour depth of 8 bit per pixel, with a resolution the same as the display itself, i.e. of 2K×2K in this case.

The various circuit elements or pixel processing elements described may comprise e.g.—but not limited to—dedicated computation means such as a programmable logic device, sometimes referred to as PAL, PLA, FPGA, PLD, EPLD, EEPLD, LCA or FPGA. The latter are well-known integrated circuits that provide the advantages of fixed integrated circuits with the flexibility of custom integrated circuits. Such devices allow a user to electrically program standard, off-the shelf logic elements to meet a user's specific needs. In particular, such processing engines may be embedded in dedicated circuitry such as a VLSI. Also a digital signal processor (DSP), a general purpose processor (GPP), an application specific integrated circuit (ASIC), a microprocessor, a microcontroller or a microcomputer can be used. Another example is a field progammable gate array (FPGA) to implement parts such as line buffers in the form of delay chains and determine phase differences of video and clock edges or other timings. Another example is a microprocessor, as a separate chip, or part of an ASIC or FPGA, for performing the other tasks like creating and analysing the histogram. The FPGA is a network of reconfigurable hardware with reconfigurable interconnects controlled by a switching matrix and is favourable over e.g. an ASIC as it has a sufficiently larger performance gain for some specific applications.

As described above, a display system has a high resolution video buffer 20, and can insert a lower resolution analog video signal. It can sample the lower resolution video signal and insert it 50 without substantially reducing the resolution of the image. An advantage over software solutions is more independence from software standards. The sampling can involve asynchronous over-sampling 130 to two or more states, adequate for recreating text or attributes. Then a re-sampler 52 uses a pixel clock derived 54 by counting near coincidences of image and clock transitions, and adjusting a clock phase or frequency to minimize the count. Other variations and applications can be conceived within the scope of the claims.

1-15. (canceled)

16. A display system adapted for outputting a video output signal having a first resolution, the display system having a video buffer adapted for buffering said video output signal having the first resolution, the system furthermore being arranged to receive a second analog video signal having a second resolution, the first resolution being higher than the second resolution, and having a circuit for sampling the second video signal, wherein the circuit for sampling the second video signal is an oversampler and the system further comprises means for recreating an image from the samples of the second video signal, without substantially reducing the resolution of the image, and circuitry arranged to output the recreated image as part of the first high resolution video output.

17. The display system of claim 16, the sampling comprising sampling to two or four levels per sample.

18. The display system of claim 16, including a pixel clock generator for generating a pixel clock.

19. The display system of claim 18, wherein the oversampler is an asynchronous oversampler, and wherein the means for recreating an image from the samples of the second video signal comprises a resampler according to the pixel clock.

20. The display system of claim 16, including a single integrated circuit incorporating the means for recreating the image, a means for inserting the image into the buffer, and a means for processing the first resolution video signal.

21. The display system of claim 18, including a circuit for dynamically adjusting a phase of the pixel clock.

22. The display system of claim 18, including a circuit for dynamically adjusting a frequency of the pixel clock.

23. The display system of claim 18, including a circuit for determining a phase error of the pixel clock by determining a count of how many transitions of the pixel clock coincide with a transition in value of the sampled second resolution video signal.

24. The display system of claim 23, arranged to determine the counts for samples sampled by pixel clocks having different phases, and a selector for selecting a pixel clock according to the counts.

25. The display system of claim 16, wherein the circuitry arranged to output the recreated image is arranged to insert the samples into the buffer for the first resolution video signal.

26. The display system of claim 16, wherein the second low resolution image is stored without resealing.

27. The display system of claim 16, including a circuit for detecting line and frame sync signals of the second resolution video signal and adapting the sampling according to the detected line format.

28. The display system according to claim 16, further comprising a graphics controller with a first high-resolution output and a second lower resolution analog output, the first resolution output being digitally connected to a processing engine for video processing, and the second resolution analog output being connected to a video connector.

29. The display system according to claim 28, wherein an auxiliary display is connected to the video connector.

30. A system comprising a computer, a video system for a first resolution, and a display system of claim 16, the display system being coupled to display a first resolution video output from the first resolution video system, and being coupled to incorporate a second resolution video stream from the computer system into the first resolution video output, the first resolution being higher than the second resolution.

31. A method of displaying a second image of lower resolution by a first high resolution video signal with higher resolution, the method comprising:
providing a first high resolution video output corresponding to the first video signal,
receiving a second lower resolution analog video signal corresponding to the second image;
sampling the second lower resolution video signal, wherein the sampling of the second lower resolution video signal is constituted by an oversampling and,
recreating an image from the samples of the second lower resolution video signal without substantially reducing the resolution of the image, and outputting the recreated image as part of the first high resolution video output.
